(19) United States
(12) Patent Application Publication
(10) Pub. No.: US 2006/0265227 A1
(43) Pub. Date: Nov. 23, 2006

(54) Audio decoding device

(76) Inventors: Noriaki Sadamura, Osaka (JP); Kosuke Nishio, Osaka (JP)

Correspondence Address: MCDERMOTT WILL & EMERY LLP, 600 13TH STREET, N.W., WASHINGTON, DC, 20005-3096, US

(21) Appl. No.: 11/431,625

(22) Filed: May 11, 2006

(30) Foreign Application Priority Data
May 11, 2005 (JP) 2005-138296

(51) Int. Cl. G10L 21/04

(52) U.S. Cl. 704/503

(57) ABSTRACT

A header format information determination section reads header format information to determine whether or not a stream conforms to IEC 61937-6. A header format information conversion section acquires or prepares information on sync words, the sampling frequency, the number of channels and the length of audio data for a stream not conforming to IEC 61937-6, and converts the information to header format information defined in IEC 61937-6. A digital audio signal output section outputs the converted stream.

### BACKGROUND OF THE INVENTION

The present invention relates to a decoding device for MPEG (Moving Picture Experts Group), DTS (Digital Theater Systems) and other digital audio signals.

In recent years, with the progress of DVDs (digital versatile discs) and BS digital broadcasting, audio signal processors called audio/visual (AV) amplifiers have come to include a decoding device (see ISO/IEC 13818-7 and ISO/IEC 14496-3). Signal processors in recent DVD players and the like have an IEC 61937-6-based output terminal for outputting a digital audio signal. Also, audio signal processors are provided with an IEC 61937-6-based input terminal via which a digital audio signal is received and decoded.

With the advance of the digital audio technology, new digital audio standards have emerged one after another, some of which are not compatible with IEC 61937-6. Examples of such standards include MPEG-4 AAC (Advanced Audio Coding) storage type (ADIF and MP4FF) and multi-channel type (LATM).

With the emergence of such new digital audio standards, there have occurred situations to which decoding devices in the existing audio signal processors fail to respond.

### SUMMARY OF THE INVENTION

An object of the present invention is providing an audio decoding device capable of converting an input digital audio signal to a digital audio signal conforming to a given digital interface standard.

To attain the object described above, the audio decoding device of the present invention includes: an input section for receiving a coded first digital audio signal; a determination section for determining whether or not the first digital audio signal conforms to a given digital interface standard; a conversion section for converting the first digital audio signal to a second digital audio signal conforming to the given digital interface standard if the first digital audio signal does not conform to the given digital interface standard; and an output section for outputting the second digital audio signal.

According to the present invention, an output conforming to IEC 61937-6 can be obtained from an input conforming to a new digital audio standard.

### BRIEF DESCRIPTION OF THE DRAWINGS

FIG. 1 is a block diagram of Embodiment 1 of the present invention.

FIG. 2 is a block diagram of Embodiment 2 of the present invention.

### DESCRIPTION OF THE PREFERRED EMBODIMENTS

Hereinafter, preferred embodiments of the present invention will be described with reference to the accompanying drawings.

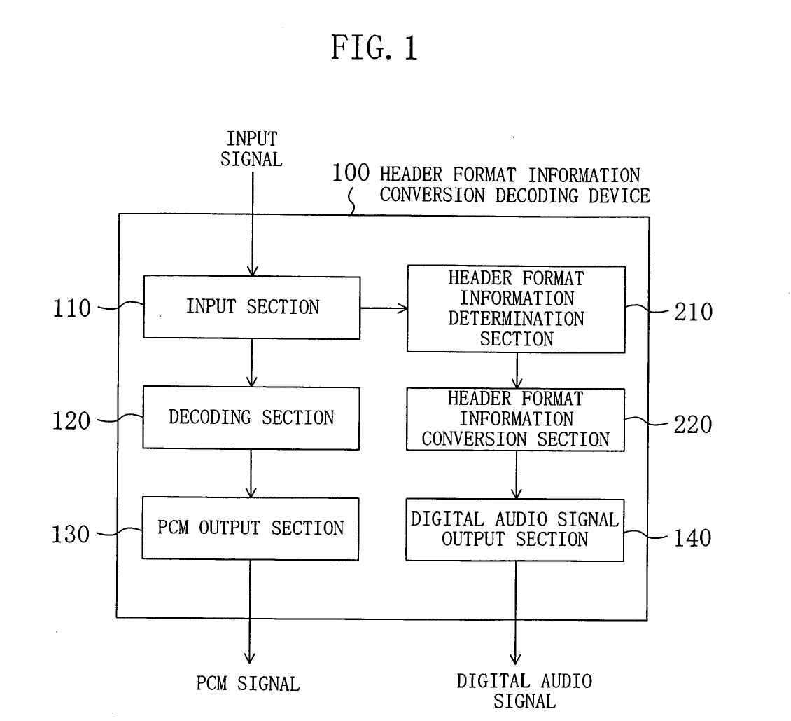

FIG. 1 is a block diagram of an audio decoding device of Embodiment 1. The audio decoding device of FIG. 1, which is configured as an MPEG-4 AAC header format information conversion decoding device 100, includes, in addition to an input section 110 for receiving a digital audio signal, a decoding section 120 and a pulse code modulation (PCM) output section 130, a header format information determination section 210, a header format information conversion section 220 and a digital audio signal output section 140.

Referring to FIG. 1, the header format information determination section 210 reads header format information from the digital audio signal input via the input section 110, determines from the header format information whether or not the signal is an IEC 61937-6-defined stream, and outputs the determination result to the header format information conversion section 220. The header format information conversion section 220 acquires or prepares information on sync words, the sampling frequency, the number of channels and the length of audio data for a stream not defined in IEC 61937-6 (for example, ADIF and MP4FF of storage type, LATM of multi-channel type), converts the information to header format information defined in IEC 61937-6, and sends the converted stream (ADTS of transport type) to the digital audio signal output section 140. The digital audio signal output section 140 outputs a digital audio signal.

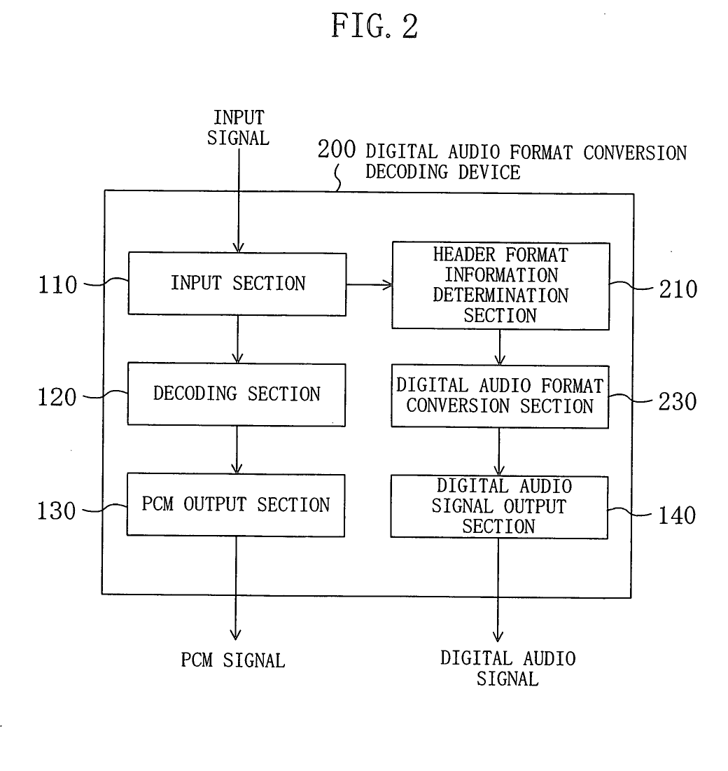

FIG. 2 is a block diagram of an audio decoding device of Embodiment 2. The audio decoding device of FIG. 2, which is configured as a digital audio format conversion decoding device 200 for executing conversion to MPEG-2 AAC LC (Low Complexity), is different from the device of FIG. 1 in that the header format information conversion section 220 in FIG. 1 is replaced with a digital audio format conversion section 230.

Referring to FIG. 2, the header format information determination section 210 reads header format information from the digital audio signal input via the input section 110, identifies the coding system (MPEG-4 AAC LC), and outputs the result to the digital audio format conversion section 230. The digital audio format conversion section 230 acquires or prepares information on sync words, the sampling frequency, the number of channels and the length of audio data from the digital audio signal of the identified coding system, changes the recognition part of PNS (Perceptual Noise Substitution) information and its information contents to thereby convert the signal to a stream conforming to MPEG-2 AAC LC, and sends the converted data to the digital audio signal output section 140. The digital audio signal output section 140 outputs a digital audio signal.

As described above, the audio decoding device of the present invention can provide a highly practical effect of enabling conversion to a digital audio signal acceptable by an AV amplifier conforming only to IEC 61937-6. Therefore, the audio decoding device of this invention is useful as an audio decoding device in DVD players and the like, and thus has high industrial applicability.

What is claimed is:

1. An audio decoding device comprising:
an input section for receiving a coded first digital audio signal;
a determination section for determining whether or not the first digital audio signal conforms to a given digital interface standard;
a conversion section for converting the first digital audio signal to a second digital audio signal conforming to the given digital interface standard if the first digital audio signal does not conform to the given digital interface standard; and
an output section for outputting the second digital audio signal.

2. The device of claim 1, wherein the conversion section converts only header format information of the first digital audio signal.

3. The device of claim 2, wherein the first digital audio signal is of MPEG-4 AAC storage type or multi-channel type, and the second digital audio signal is of MPEG-4 AAC transport type.

4. The device of claim 1, wherein the coding system of the first digital audio signal is MPEG-4 AAC, and the coding system of the second digital audio signal is MPEG-2 AAC.
